(19) United States
(12) Patent Application Publication
(10) Pub. No.: US 2023/0251089 A1
(43) Pub. Date: Aug. 10, 2023

(54) MOBILE SCANNING ARRANGEMENT AND METHOD FOR CONTROLLING A MOBILE SCANNING ARRANGEMENT

(71) Applicant: Zoller & Fröhlich GmbH, Wangen im Allgäu (DE)

(72) Inventors: Christoph Fröhlich, Wangen (DE); Christoph Held, Lindenberg (DE); Markus Mettenleiter, Isny (DE)

(73) Assignee: Zoller & Fröhlich GmbH, Wangen im Allgäu (DE)

(21) Appl. No.: 18/029,918

(22) PCT Filed: Oct. 6, 2021
(86) PCT No.: PCT/EP21/77624

§ 371 Date: Apr. 2, 2023

(30) Foreign Application Priority Data
Oct. 6, 2020 (DE) 102020126106.3
Dec. 21, 2020 (DE) 102020134414.7
Jun. 11, 2021 (DE) 102021115186.4
Sep. 21, 2021 (DE) 102021124440.4

(51) Int. Cl. G01C 15/00; G01S 17/894; G01S 7/481

(52) U.S. Cl. CPC G01C 15/002; G01S 17/894; G01S 7/4813

(57) ABSTRACT

A mobile scanning assembly and a method for driving such a scanning assembly allow a very flexible execution of a measuring procedure in a SLAM rotation mode, an MMS profile mode and/or using a static scan and an evaluation via an onboard PC to optimize the trajectory and the resulting 3D cloud of points.

### CROSS REFERENCE TO RELATED APPLICATIONS

The present patent application is a national stage of, and claims priority to, PCT Application No. PCT/EP2021/077624, filed on Oct. 6, 2021, which application claims the priority of the German patent application 10 2020 126 106.3 filed Oct. 6, 2020, German patent application 10 2020 134 414.7 filed Dec. 21, 2020, German patent application 10 2021 115 186.4 filed Jun. 11, 2021 and German patent application 10 2021 124 440.4 filed Sep. 21, 2021, the disclosures of which are incorporated by reference in the present patent application in their entireties.

### TECHNICAL FIELD

The disclosure relates to a mobile scanning assembly according to the preamble of patent claim 1 and to a method for driving such a scanning assembly.

### BACKGROUND

Document EP 3 056 923 A1 of the Applicant discloses a scanning assembly with at least one laser scanner that can scan objects located in the field. The scanning assembly is configured with a memory for storing project-related data and an integrated computer and with a navigation unit for detecting a scanner position and/or a relative scanner position to a starting position. Furthermore, the scanning assembly has a satellite computer, for example a tablet, which can perform a registration of the scan in the field in a project-specific coordinate system in parallel with a subsequent scanning process via the laser scanner.

The disadvantage of such a scanning assembly is that it is only mobile to a limited extent. Strictly speaking, the scanning assembly has to be moved from one location to another, wherein the laser scanner is usually mounted on a stand or something similar.

Mobile scanning assemblies with and without SLAM (Simultaneous Localization And Mapping) technology are also known from the prior art. SLAM technology or SLAM mode often has the disadvantage of relatively low pixel density, inhomogeneous coverage of the environment, and comparatively reduced 3D accuracy.

Document EP 3 280 977 B1 shows a mobile scanning assembly that can also be operated according to a SLAM mode, in which a 3D reference map is created in a first step and then, in a subsequent step, based on the 3D reference map, the environment is scanned in a SLAM mode via a 3D scanner and a position determination is performed at the same time, so that the current location of the 3D scanner is known. The current scanner data is then recorded within the existing 3D reference map and can be displayed on a real-time user interface (for example, in a tablet).

According to one configuration example, the 3D laser scanner is positioned on a back frame with shelf, which also carries a CPU for evaluating the data acquired by the scanner and the location data acquired during the SLAM mode. A tablet is also assigned to this scanning assembly, via which information processed by the CPU is displayed.

Furthermore, so-called MMS systems (Mobile Mapping System), which operate in an MMS mode, are known from prior art. The big disadvantage is that no SLAM can be calculated with these data, since the (essentially parallel) profiles do not have sufficient overlap—thus it depends solely on the INS (Inertial Measurement System) accuracy of the MMS system, which is therefore very high quality and therefore expensive.

Scanning assemblies are also known in which a laser scanner is mounted on a carrier vehicle (SKID, AGVS). This vehicle moves in the environment while the laser scanner takes scans of the environment.

The disadvantage of these known mobile scanning assemblies is that the laser scanner, as one of the main components of the scanning assembly, is only usable for one specific application. In addition, the 3D accuracy and resolution of such systems are considerably poorer than with fixed recording points.

### SUMMARY

In contrast, the object of the disclosure is to create a mobile scanning assembly that can be flexibly adapted to the specific application and that enables fast and accurate detection of large regions.

The disclosure is also based on the object of creating a method for effectively driving such a scanning assembly.

This object is solved with respect to the mobile scanning assembly by the features of a first independent patent claim and with respect to the method by the features of a second independent patent claim.

Further advantageous examples of the disclosure are the subject matter of the dependent claims.

The mobile scanning assembly according to the disclosure has a mobile platform on which at least one scanning device for 2D or 3D measurement of objects/regions is arranged. The platform is held in such a way that it can be moved along a predetermined path of movement along the region to be measured and has a computing unit (CPU) that is in data connection with the scanning device. The mobile scanning assembly furthermore has a device for location detection. The computing unit makes it possible to evaluate the data determined via the scanning device, which is preferably operated in an MMS rotation mode, in particular an MMS SLAM rotation mode, and the device for location detection, and to determine a trajectory (movement path) of the scanning device, wherein the computing unit is adapted, in the event of insufficient data quality of the trajectory or of the resulting scan, to determine at least one position for additionally performing a static scan and to output corresponding information or a signal for performing a further mobile scan, preferably in a profile mode.

Such a mobile scanning assembly can be used very flexibly, wherein it is ensured that due to the different measuring principles (static mode and MMS mode) a highly precise detection of the object or the region to be measured, for example a production hall, is possible.

In a preferred configuration example, the computing unit integrated in the platform is synchronized with at least one of the scanning devices so that the scans and location data acquired in mobile and/or static mode can be synchronized with the scan data stored in the scanning device. In this context, it is particularly preferred if the computing unit is configured in such a way that it can process the scans and location data acquired in mobile and/or static mode with the aim of registration in the field (on site). This registration can then be carried out via the computing unit or via an external computer assigned to the scanning device.

It is particularly preferred if the computing unit is adapted in such a way that the processed data sets/scan data can be transmitted back to the evaluation unit of the scanning device—in other words, the synchronization of the data sets takes place between the platform-side computing unit and the at least one scanning device in both directions.

In one variant of the disclosure, the aforementioned pre-registration in the field takes place via an external computer, for example a tablet (handheld device) or via the computing unit, which is in data connection with the scanning device.

Further processing in a central processor or the like is facilitated if the computing unit has an interface for an external memory, for example an SSD or a USB stick, on which the project data, i.e. the data resulting from the synchronization of the computing unit and the internal computer of the scanning device, can be stored.

The scanning assembly is able to be used in a particularly variable manner when the platform has at least two receptacles for optional positioning of a scanning device or for positioning of at least two scanning devices. This type of configuration makes it possible to position the scanning device in the respective optimum position on the platform depending on the object/region to be measured. In principle, two scanning devices can also be mounted so that two scans can be acquired during one movement of the scanning assembly.

It is particularly preferred if the receptacles for the scanning devices are set at a predetermined angle to each other.

The quality of the measurement can be improved with comparatively little technical effort if the scanning device is a 3D or 2D laser scanner and/or a camera.

The location detection device may be an IMU/INS-based or GNSS-based system or a system that uses localization techniques such as radar, Bluetooth, ultrasound, or RFID.

The method according to the disclosure for driving a mobile scanning assembly, in particular a mobile scanning assembly with the preceding features, accordingly assumes a scanning device that is positioned on a mobile platform and that is configured with a computing unit that is synchronized with the scanning device. According to the disclosure, driving of such a mobile scanning assembly is performed in such a way that, in a first step, a mobile data set is generated via the scanning device, which is preferably operated in an MMS rotation mode, in particular an MMS SLAM rotation mode, and is assigned to the object/region to be measured. This mobile data set acquired via the scanning device is then evaluated via the computing unit and a trajectory is calculated.

In a further step, the trajectory or mobile data set (scans) is analyzed and, if applicable, a signal is output for performing a static scan from a location determined by the computing unit or another mobile scan, preferably in a profile mode of the scanning device.

The static scan or the further mobile scan and the mobile data set from the first measurement are then evaluated to determine a corrected mobile data set and a corrected trajectory, which are synchronized with the scanning device if applicable.

Such a method enables high-precision detection of an object/region to be measured with a minimum of device-related and process engineering effort.

The method according to the disclosure is particularly effective if, on the basis of the corrected data set in the field, a pre-registration or a correction of a registration is carried out via the computing unit or via an external computer in data connection with the scanning device. This external computer may, as mentioned above, for example be a tablet associated with the scanning device.

Further processing of the trajectory and mobile data sets is particularly easy if these data are stored on an external memory.

The method described above can be used particularly effectively in a scanning assembly with a 3D laser scanner, via which a first mobile data set is generated in an MMS rotation mode, preferably a SLAM rotation mode, and, if applicable, the static scan. It is preferred if at least a second mobile data set is generated via the 3D laser scanner operated in a profile mode along the same path of movement (if applicable in the opposite direction) or via a further 2D laser scanner held on the platform. This double detection of mobile data sets results in an optimization of the trajectory and the resulting 3D cloud of points, wherein all available data and loop closures from other passes, control points and also the aforementioned static scans can be taken into account via the CPU.

The acquisition of the static scan is particularly accurate if the scanning device is removed from the platform and moved to an optimal measuring position. The 3D laser scanner or scanning device can then be mounted on a stand or the like.

Further innovative aspects of the disclosure are addressed below.

The platform, on which all components can be precisely mounted, can be configured differently depending on the application. The platform may contain several, preferably adjustable, devices to hold one or more scanners at different angles.

The laser scanner, which can be detachably attached to the platform in a defined orientation (preferably vertically or tilted backwards) so that it can be removed at any time and can be set up on a stand in the traditional manner, is also adapted to take static scans. A particular advantage of this configuration of a scanning assembly is its mobile and flexible applicability. The scanner can be operated both on the platform and independently as a stand-alone device at fixed viewpoints. The platform is also adapted in such a way that it can be mounted on a SKID/push cart or a carrying frame.

Preferably, the scanning assembly has an integrated or separate camera unit consisting of several cameras that record images in the visible and/or infrared and/or multispectral range. This camera unit is preferably configured as a 360° panoramic camera system, whereby the entire environment can advantageously be captured in a data set also referred to as a panorama.

In a particularly preferred configuration example, the platform of the scanning assembly has an electronic unit that contains essential electronic components required for generating supply and control signals as well as the computing unit and a navigation system (INS (Inertial Navigation System) & optionally GNSS (Global Navigation Satellite System)). The electronic unit can also be used to establish a preferably wireless connection from the computer to a handheld device, e.g. smartphone, tablet or the like, via which the operator can control and/or monitor the overall system.

The transformations relative to the INS (Lever Arms) of the scanner and camera are preferably determined by calibration, so that the data of all components, synchronized via a common ‘PPS’ pulse, can be transformed into a uniform coordinate system.

Preferably, the platform and/or the electronic unit is adapted to hold a base board. This base board is used, among other things, for coupling and connecting different components of the scanning assembly.

As explained, a computing unit is mounted on or in the platform and/or is part of the electronic unit. Since this is directly or indirectly connected to the platform, it is also referred to as an onboard PC and can be used directly in the field. It can control the individual components and/or generate a live preview that is displayed to a user on a satellite computer, such as a handheld device, tablet, or the like.

Depending on the configuration, it may be advantageous to provide accumulators for supplying power to the electrical components. Particularly preferably, the accumulators are attached to or in the platform in such a way that they are easily accessible and can thus be replaced in a short time. This exchange can take place during a scanning process so that it does not have to be interrupted. Thus, during a measurement in the field, the running time of the scanning assembly can be significantly extended by replacing the accumulators. Furthermore, the accumulators may be integrated in or on the platform in such a way that they also supply the laser scanner with power, so that the accumulators of the laser scanner are not necessarily held on the laser scanner itself. This reduces the weight of the laser scanner and the rotating mass, which is beneficial for the quality of the receptacles.

In an advantageous example, a DC-to-DC converter is provided for the scanning assembly, which is also held on or in the platform, in particular as part of the electronic unit. Advantageously, different accumulator types can be used. The voltages may be between 6V and 48V and the DC-to-DC converter adapts these to the operating voltage of the scanning assembly or the individual components.

In a preferred further development, the laser scanner is connected to the platform via an adapter with a receptacle device attached to the platform. Advantageously, exact orienting is thus ensured in a simple manner.

In a particularly preferred configuration example of the mobile scanning assembly according to the disclosure, an inertial sensor is provided on the platform that is oriented such that its orientation to the laser scanner is fixed and known.

In an alternative configuration example, the onboard PC and most of the other components of the electronic unit are integrated inside the platform so that external data carriers are connectable via interfaces. Advantageously, the entire platform can be converted from one portable device to another without having to dismantle and reassemble individual parts of the electronic unit.

Preferably, a cargo backpack, such as a so-called ‘Kraxe’, i.e. a back frame with shelf, is used as the portable device. The platform can be mounted on the portable device, for example the back frame with shelf, in just a few steps. Advantageously, such back frames with shelf are ergonomically optimized, so that a user can bear the load of the scanning assembly even over a longer period of time without problems.

In a further preferred configuration example, the portable device is a production platform. In particular, it may be a so-called SKID platform or an AGVS (automated guided vehicle system), which are used, for example, in larger production lines, for example in the automotive industry. The platform can be quickly mounted on a SKID conveyor or the AGVS without intervening in the production process and can scan and detect the entire production hall in one pass. A SKID is preferably used to scan the interior space of the production hall, while walking/travel paths and outdoor facilities are preferably scanned via an AGVS.

In an alternative preferred configuration example, the portable device is an item that can move in a variety of ways. For example, it may drive, fly, or swim. A diving item, or a crawling item are also conceivable, as long as a suitable receptacle for the platform is provided, so that the mobile scanning assembly with the platform can be attached to the item.

A configuration example of the method according to the disclosure has the following steps:

In a first step, the target object is acquired in one pass in a SLAM rotation mode. This is a typical operating mode of SLAM systems already available on the market. Advantageously, large regions can be captured very quickly from a continuous motion.

In a second optional step, the scene is captured in an MMS profile mode. This mode is primarily used in classic, mostly vehicle-based, MMS systems. The advantage is being able to scan large regions quickly, wherein the accuracy and data density is much higher and also more homogeneous than when using a SLAM-rotation mode.

In a third, optional step, single scans are taken at stationary points where a very high resolution is required. These single scans are performed in a classical laser scanner mode, where many single points are acquired. Advantageously, the resolution and the 3D accuracy are very good in this mode.

The individual steps are shown in more detail below.

According to the first step, a very accurate SLAM-based trajectory of the scan's motion is generated after the measuring is completed, wherein already a favorable INS can be sufficient to estimate the position. If possible, at least one loop closure (return to the starting point or to individual objects during the detection) is acquired to compensate for slow drifts of the trajectory.

In the second step, for example, the same route from the first step is run or traversed again, wherein, however, scanning is performed in profile mode. The (approximately parallel) profiles are oriented using the SLAM algorithm based on the data already generated from the first pass, greatly increasing the data density and homogeneity of the 3D data while maintaining approximately the same accuracy.

In an optional third step, individual scans in the classic laser scanner mode, i.e. a spherical 3D scan at a fixed viewpoint, can be acquired at a few, particularly critical, points, either in order to determine certain reference objects with high precision or to measure certain objects with particularly high resolution. The individual viewpoints are at least approximately known to the system, either via the SLAM algorithm or via the internal sensors of the scanning assembly or of the laser scanner, so that these scans can advantageously be registered seamlessly with the existing data set.

Advantageously, by using the method according to the disclosure, a high-resolution, high-precision 3D cloud of points of a large region is obtained in a short time, wherein accuracy and resolution correspond to that of the classical laser scanner mode—and this without the use of expensive INS systems. Likewise, the use of additional laser scanners can be dispensed with in an advantageous manner.

In a preferred configuration example, the individual images, also called 3D scans, are registered in the field. Once the scans from the laser scanner mode have been registered to the data set acquired in SLAM mode, they can, due to their high accuracy, serve as a reference in order to orient the profiles of the SLAM data set even more precisely, which is preferably done automatically. Also, several independent but overlapping SLAM data sets could serve each other as reference. In the case of captured reference objects, the trajectory computed in SLAM can be drawn to so-called ‘tie-points’ and can thus be improved with high precision. Of course, tie points may also be generated in other ways, for example by the camera system or with the help of target marks captured by the laser scanner in static use.

Similarly, the trajectory estimation for the SLAM data set can be improved by including, for example, differential GNSS data.

In a preferred configuration example of the method according to the disclosure, the camera unit can advantageously be used to further improve the trajectory via appropriate video geometry evaluation, for example estimation of the motion by tracking features in successive images, or video SLAM.

The second step can be saved if the scanning assembly used is equipped with an additional profile scanner that acquires additional approximately parallel profiles already during the first pass and whose data is oriented to the data of the first scanner using the SLAM process.

The Applicant reserves the right to make an independent claim for the platform with the receptacles for the scanning device and the integrated computing unit (onboard PC).

### BRIEF DESCRIPTION OF THE DRAWINGS

Configuration examples of the disclosure are explained with reference to drawings.

FIG. 1 shows a configuration example of a mobile scanning assembly according to the disclosure in a perspective illustration,

FIGS. 2a and b show a laser scanner in two different operating modes,

FIGS. 3a to 3e show different arrangements of a mobile scanning assembly with regard to the positioning of the components on a platform;

FIGS. 4a to d show examples of use of a mobile scanning assembly according to the disclosure;

FIGS. 5a, 5b show three-dimensional views of a platform of the scanning assembly according to the disclosure;

FIG. 6 shows a basic illustration of essential components of a scanning assembly according to the disclosure;

FIG. 7 shows a general flow chart of a method according to the disclosure for generating a mobile data set and for determining a trajectory, and

FIG. 8 shows a concrete flow chart in which a 3D laser scanner is used to acquire a 3D cloud of points of a region to be measured.

### DESCRIPTION

FIG. 1 shows a configuration example of a mobile scanning assembly 1 according to the disclosure. It has a 3D laser scanner 2, which in this configuration example is mounted on a tripod 4 or another support bracket. Furthermore, the scanning assembly 1 has a camera unit 6 that is spaced apart from the laser scanner 2. The camera unit 6 is arranged in such a way that it has a largely unobstructed view of the scene. The camera unit 6 is also spaced from a platform 8 supporting the laser scanner 2—it is also conceivable that the camera is integrated in the platform or in the scanner in order to record images in profile mode with a view as parallax-free as possible. The laser scanner 2 is connected to the platform 8 via the tripod 4 or another suitable device and a receptacle described in more detail below, wherein an inclined (approx. 45° inclination) or vertical position is preferred. If the orientation of the laser scanner 2 on the platform 8 is not exact, this can be compensated for by an electronic compensator of the laser scanner 2.

An inertial sensor not shown in the Figure should be positioned in a predetermined relative position approximately centered below the laser scanner 2.

The platform 8 is configured with an electronic unit, which is configured with an onboard PC and a DC-to-DC converter. The onboard PC has for example threads on its rear side, which are for example formed in the manner of a VESA receptacle. Thus, the onboard PC, which is configured with rubber feet, if applicable, can be screwed to the platform or can be secured against slipping and vibrations with another type of mount within the technology unit.

At least one accumulator 10 is mounted on an upper side of the platform 8. Preferably, several accumulators 10 are held on the platform 8 in such a way that they are easily replaceable in order to enable a longer scan time in the field. The accumulators are preferably interconnected in such a way that at least one accumulator can be replaced without interrupting the scan.

In this configuration example, the camera unit 6 is attached to a cargo backpack 12 via an angled bracket. A profile is attached approximately in the middle of the angled bracket, to which the camera unit 6 is mounted. The angled bracket is, for example, screwed to a frame of the cargo backpack 12 on both sides, or is detachably attached in another way. In particular, it is advantageous if the mounting of the camera unit 6 is configured in such a way that it is rigidly configured relative to the frame of the cargo backpack 12. This makes calibration of the scanning assembly 1 much easier. Cables of the camera unit 6 are routed along a side of the cargo backpack 12 facing away from a user to the onboard PC.

The mobile scanning assembly 1 has a total of three operating modes, wherein the third operating mode is explained in more detail in a later figure.

FIG. 2 schematically shows two operating modes (MMS rotation mode, profile mode) of the laser scanner of the mobile scanning assembly 1.

In MMS or SLAM rotation mode, the laser scanner 2 is located on the moving platform 8 and rotates (a few times per second) around its vertical axis X, while a rotor 11 ensures a rapid vertical deflection of the scanning laser beam 14. According to the illustration in FIG. 2a, a helix of vertical profiles twisted around the vertical axis is created (by the horizontal movement of the platform), which thus have a large overlapping area. This overlap is essential for the SLAM algorithm, which can calculate the exact trajectory and thus the transformation of all recorded data only from this (and the motion estimation of the INS).

FIG. 2b shows the second operating mode (profile mode). Accordingly, only the rotor 11 rotates for vertical beam deflection. The laser scanner 2 does not rotate around its vertical axis X, but keeps it at a defined angle, preferably approximately perpendicular to the direction of movement of the platform. The profiles of the laser beams 14 captured in this way are therefore approximately parallel to each other. Due to the parallel arrangement of the captured profiles, such a measurement alone cannot be used for evaluation via a SLAM algorithm, since this requires overlapping profiles.

The illustrations in FIG. 3 show different ways of positioning the scanning assembly according to the disclosure.

According to FIG. 3A, the mobile scanning assembly is mounted, for example, on a cargo backpack or a back frame with shelf, wherein the platform 8, as explained in more detail below, is configured as a housing on which the respective laser scanner 2 is mountable in a variable position. In the configuration example shown, the platform 8 has a slanted surface 13, which in the configuration example shown is set at an angle of about 45° to the vertical (of course, other angles are also possible). The laser scanner 2 is then mounted on this slanted surface 13 via a suitable adapter so that it is rotatable about its vertical axis X, for example in an operating mode as shown in FIG. 2A. The inclined position ensures that a collision between the person carrying the scanning assembly and the laser scanner 2 is not to be expected while walking through the region to be measured. Such an arrangement can also be used, for example, when mounting the scanning assembly on a sliding carriage, wherein the platform 8 is then arranged in the horizontal direction so that the vertical axis X of the laser scanner 2 is oriented upward in the sliding direction.

However, as indicated in FIG. 3B, the laser scanner 2 may also be mounted on one of the large areas 15 adjacent to the aforementioned slanted surface 13. In such a concept, the platform 8 is accordingly preferably arranged in a lying manner. Such a platform arrangement is advantageous, for example, when mounting the scanning assembly on a sliding carriage, a SKID, an AGVS or the like.

Since in such a concept the rather heavy scanning assembly is not carried by a person, the measuring speed and the flexibility of the arrangement can be improved by occupying both the large area 15 and the slanted surface 13 with a laser scanner 2. Accordingly, the platform 8 is then configured with multiple receptacles for the laser scanners 2. For example, one of the laser scanners 2 can be operated in the SLAM rotation mode, while the other laser scanner 2 operates in the profile mode described above. The evaluation of both scans to determine the mobile data set and the trajectory is then performed by the onboard PC described in more detail below.

In this configuration example, the platform 8 is also arranged in the horizontal direction.

In the configuration example according to FIG. 3D, a 3D laser scanner, for example the IMAGER® of the Applicant, is mounted on the large area 15, while a 2D laser scanner, for example the Profiler® 2′ of the Applicant, is mounted on a narrow side 17 of the platform 8 running in the vertical direction. Accordingly, the IMAGER® is used for the rotation mode and the Profiler® 2′ for the profile mode. Both measurements can be performed simultaneously.

In principle, it is also possible to fill both positions with an IMAGER® 2 or a Profiler® 2′. When using two Profilers® 2′, the SLAM algorithm can be used, since the profiles overlap due to the oblique position.

Finally, FIG. 3E shows a relative positioning in which the Profiler® 2′ is arranged on the narrow side 17 in the vertical direction so that the profile is correspondingly detected in the horizontal direction.

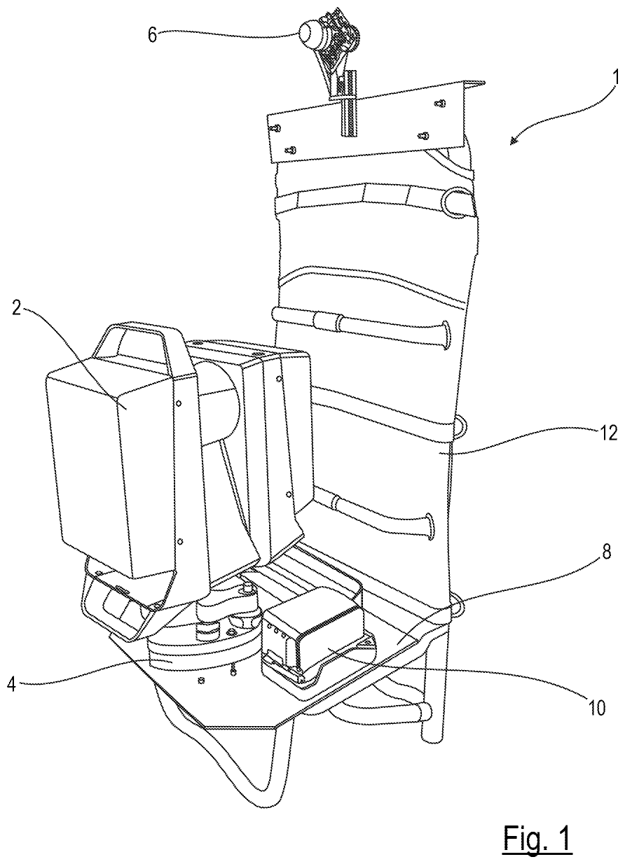

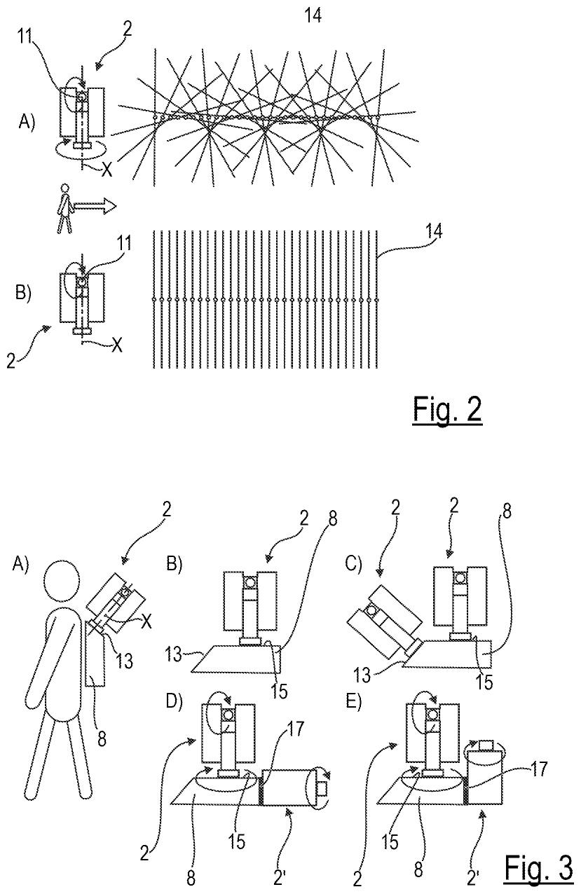

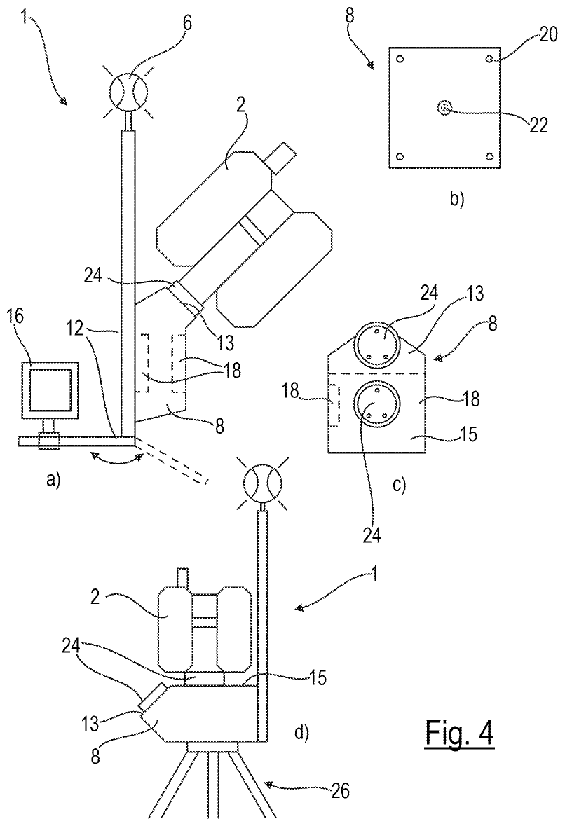

FIG. 4a shows a mobile scanning assembly 1 with a laser scanner 2 that is held at an angle of approximately 45° on the slanted surface 13 of the platform 8. This is held on the frame of a cargo backpack 12. This frame has, inter alia, a detachable handheld device 16 (tablet) in a lower, angled region. Furthermore, the camera unit 6 is shown, which is provided at an upper end of the cargo backpack 12. The platform 8 has lateral battery compartments 18 indicated with dashed lines, into which accumulators can be inserted to power the mobile scanning assembly 1. This will be explained in more detail below.

FIG. 4b shows an underside of the platform 8 with which it can be mounted on a transport device. For this purpose, thread holes 20 are provided in corner areas of the platform, via which relatively small screws can hold the platform on the intended transport device. A somewhat larger thread hole 22 is provided centrally or at the center of gravity on the underside of the platform 8, via which a central screw connection to the transport device can be achieved.

FIG. 4c shows an upper side of the platform 8, wherein the slanted surface 13 is indicated in a region shown here above and indicated by a dashed line, which is positioned, for example, at an angle of approximately 45° to the large area 15 of the platform 8. Receptacles 24 are provided both in the slanted surface 13 and on the large area 15 of the platform 8, which are used for receiving laser scanners 2. The receptacles 24 may be configured, for example, as a bayonet lock or may have an external thread, or may have receptacle bores and/or may also have threaded bolts that are used for fixed positioning of the laser scanner 2.

FIG. 4d shows a mobile scanning assembly 1 with the laser scanner 2, the camera unit 6 and the platform 8, which has two receptacles 24, on a stand 26. This arrangement is used, for example, to apply the third operating mode described below.

In the third operating mode, the laser scanner 2 is preferably dismounted and takes a conventional panoramic scan from a fixed viewpoint, typically a stand 26. If the platform 8 is stationary, the scanner can also remain mounted on the platform 8 to take a conventional 360° scan.

In the configuration example shown in FIG. 4d, the scanner 2 is mounted with the platform 8 on the stand 26. In principle, the scanner 2 can also be detached from the platform 8 and can then be positioned on a stand 26 or something similar. In this case, however, it has to be ensured that the static scans are synchronized with the onboard PC of platform 8.

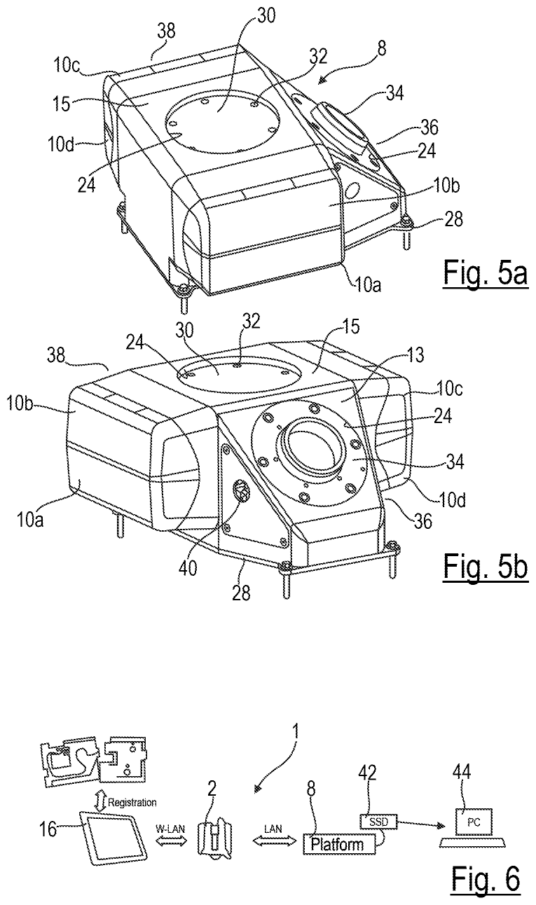

FIGS. 5a, 5b show specific examples of the platform 8. As already explained above, this is mounted on a base plate 28, which in turn is mounted via screws or the like on the respective mobile support structure, for example the cargo backpack 12, the SKID, an AGVS or a pushcart.

As explained, the platform 8 has a housing with a housing wall forming the large area 15, which runs parallel to the base plate 28. A receptacle 24 for a support bracket of a laser scanner 2 (IMAGER®, Profiler®) is arranged in this housing. In the configuration example shown, the receptacle 24 is pocket-shaped, wherein fastening threads 32 for a support flange are provided at a bottom 30, which is configured in accordance with the mechanical interface of the laser scanner 2.

In the illustration according to FIG. 5a, the large area 15 is followed to the right by the slanted surface 13, on which a receptacle 24 is also formed, into which a support flange 34 for the laser scanner 2 is inserted according to the illustration in FIGS. 5a and 5b.

Four accumulators 10a, 10b, 10c, 10d are positioned on side walls of the platform housing, wherein each of these accumulators is individually replaceable and interconnected to provide power during operation of the laser scanner(s) 2. In the configuration example shown, the four accumulators 10a, 10b, 10c, 10d are positioned in the region of the side walls of the housing adjacent to the large area 15.

A housing region 36 forming the slanted surface 13 is slightly stepped back on both sides compared to a housing region 38 forming the large area 15, so that the slanted surface 13 is correspondingly narrower than the large area 15. The housing regions 36, 38 house the onboard PC described above, which is configured to be powerful so that it can perform the data processing described above at high speed, thus enabling immediate data processing. The housing furthermore includes the communication interface which performs synchronizing the data processed by the onboard PC with the data sets stored in the laser scanner(s) 2. Furthermore, there may be an additional communication interface in the housing for a data connection with an external computer (tablet, handheld device) 16. In principle, however, it may also be sufficient if this communication takes place via the respective scanning assembly (for example, the laser scanner 2). Parts of the onboard PC and of the communication modules are marked with the reference sign 40 in FIG. 5b.

FIG. 6 again schematically shows the essential assemblies of the mobile scanning assembly according to the disclosure. As explained above, this comprises a laser scanner 2, for example at least one IMAGER®, which may be mounted on a platform 8 as shown in FIGS. 5a, 5b. This laser scanner 2 communicates via a radio link, for example W-LAN, with the external computer, for example the handheld device 16, via which a pre-registration can be carried out in the field—this is indicated in FIG. 6, top left. Real-time preview scans of the SLAM data acquired via the mobile scanning assembly 1 can also be displayed on this handheld device.

As explained above, the laser scanner 2 is in data connection, for example via a LAN, with the platform 8, via which an evaluation of the location data and the 3D cloud of points acquired via the laser scanner 2 takes place. Depending on the configuration, this laser scanner 2 may be operated in the MMS/SLAM-rotation mode and in profile mode to generate a highly accurate trajectory. As explained, the platform 8 is configured with an external interface for connecting an SSD 42 or a USB stick, via which the data acquired by the onboard PC 40 can be read out and transmitted to a central processor 44. Of course, this transmission can also be contactless.

As already explained at the beginning, the onboard PC 40 can synchronize with the connected laser scanners 2, 2′ due to its powerful CPU and can store all stationary data of a project locally on the platform 8. The scans can also be registered with each other and with the SLAM data. In principle, it is also possible to perform processing of the data (data filter, person recognition and masking (data protection), target recognition, colorization, a data export, etc.) via the onboard PC 40.

The stationary data is then copied to the external memory 42 together with the SLAM data. If, for example, this is removed and inserted into the central processor 44, the entire project, for example stationary scans and SLAM data, can be evaluated together without having to download any additional data from the laser scanners 2.

Furthermore, preview scans of the SLAM data in the field can be synchronized to the laser scanner 2 and can be integrated into the project. This means that the previous field workflow can continue to be used, as described, for example, in the prior art described at the beginning according to EP 3 056 923 A1 of the Applicant.

The laser scanner 2 can then send all data of a project (stationary scans and SLAM data) to the handheld device 16, where the registration can then be made or corrected. The handheld device 16 synchronizes the changes back to the laser scanner 2, which in turn synchronizes the changes to the platform 8 and the external memory 42 connected to it.

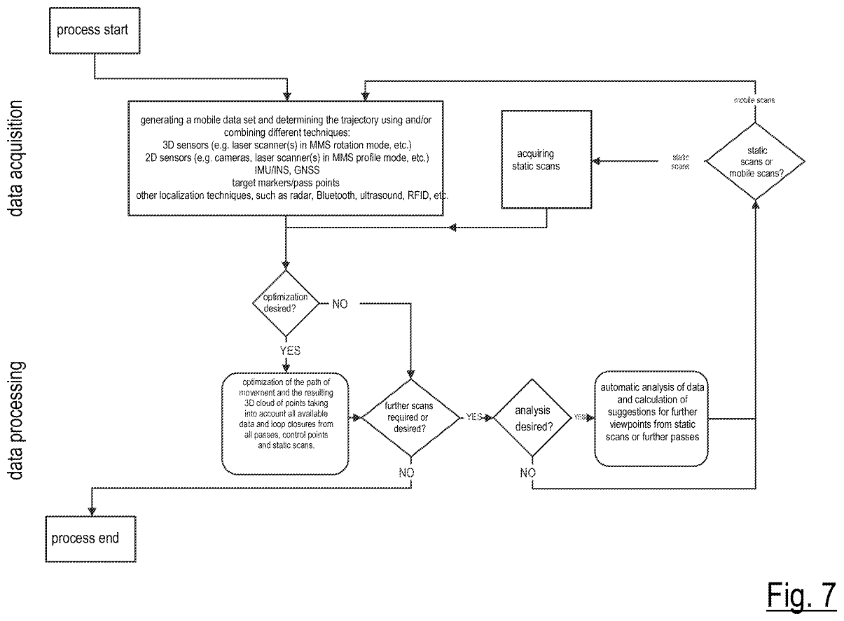

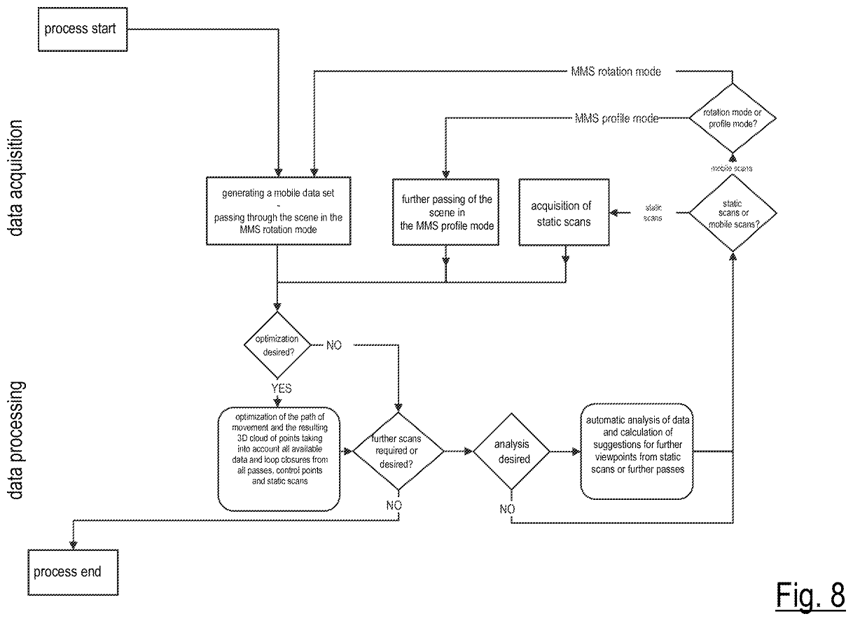

Further details of the method according to the disclosure are explained below with reference to FIGS. 7 and 8.

FIG. 7 shows the basic concept according to the disclosure, while FIG. 8 shows a concrete solution with laser scanners.

It is assumed that the interior of a production hall is to be measured via the scanning assembly according to the disclosure. The scanning assembly is configured with a scanning device that is suitable for 2D or 3D measurement of objects/regions and that is mounted on the platform 8 and can be moved along a predetermined path of motion. According to the flow chart shown in FIG. 7, after the measuring procedure has been started (this start can be done, for example, by driving via the onboard PC 40 or can be generated directly via the scanning device), first a mobile data set is generated and a trajectory is determined, wherein this data set and the trajectory are generated via suitable scanning devices, for example 3D sensors (e.g. a laser scanner in the MMS/SLAM rotation mode) and/or 2D sensors (e.g. cameras, laser scanner(s) in the MMS profile mode). The location is determined inside production halls preferably via an IMU/INS-based system or a GNSS system. Target markers/pass points can also be used. In principle, other localization technologies such as radar, Bluetooth, ultrasound, RFID, etc. can also be used for location determination.

These clouds of points and also the location information are then processed via the onboard PC 40 in the platform 8 in order to determine the trajectory, etc., as explained above.

At the start or after the first evaluation of the data, it can be specified whether an optimization of the obtained data is desired. In case such an optimization is desired, an optimization of the motion path and the resulting 3D cloud of points is performed taking into account all available data and loop closures from all passes, control points and, if applicable, static scans (this will be discussed in more detail below). This optimization is then performed with the aid of the onboard PC 40. In principle, the decision whether or not to perform an optimization can also be decided on the software side via the onboard PC 40.

In the event that no optimization is desired (manual decision/input or software-supported decision), the next processing step alternatively asks whether further scans are necessary or desired; if this is not the case, the scanning process is terminated.

However, usually the aforementioned optimization of the trajectory and the 3D cloud of points is desired, so that the data processing in the next step is performed depending on a specification according to which an analysis should or should not be performed.

If such an analysis is to be performed via the onboard PC 40, an automatic analysis of the data and subsequently a calculation of suggestions for further viewpoints of static scans or for further passes in the MMS-profile mode or in the MMS-rotation mode is performed.

In the case where no analysis via the onboard PC 40 is desired, the next step is carried out directly, according to which it has to be decided manually whether further static scans or mobile scans are to be carried out. In the case of an automatic analysis, this question is usually already decided by the onboard PC 40 on the software side. If an analysis is not desired, this decision must be made ‘manually’ by the user in the field, so to speak. In accordance with this software-based or manual decision, either a further mobile scan is then performed, wherein this is carried out in the MMS/SLAM rotation mode or in the MMS profile mode, depending on the specification. This is preferably done along the same trajectory, wherein, however, not always the same loop closures have to be traversed. After performing this further mobile scan, the same method steps are then performed as explained above. Alternatively, a static scan can also be performed.

In the case where a static scan is to be performed, an analysis via the onboard PC 40 suggests a location for the static scan and the scanning device is brought to this region accordingly. In this case, the scanning device is removed from the platform 8 or from the mobile unit, for example, and is positioned on a stand 26 or the like, wherein the exact location positioning can be monitored via the systems for location determination.

After the static scan has been acquired, the data is then processed as described above. This data processing can be repeated until the data quality (of the mobile data set and the location data) meets the specifications. As a rule, it is sufficient if a survey is carried out in the MMS/SLAM rotation mode and in the MMS profile mode and, if applicable, still with a few static scans.

FIG. 8 shows a concrete flow chart for a scanning assembly 1 configured with a 3D laser scanner 2 (IMAGER®). As explained, in this configuration example, the laser scanner 2 is operated in the MMS/SLAM rotation mode in a first method step, so that a mobile data set with corresponding location data is generated via it.

Subsequently, the data is processed according to the general scheme explained in FIG. 7. In case an optimization of the SLAM data is desired, another mobile scan or a static scan is performed either manually or after an analysis via the onboard PC 40.

In the case where a mobile scan is to be performed, it is specified either manually or via the onboard PC 40 that this scan is to be performed in the MMS profile mode or in the MMS rotation mode. Typically, the second mobile scan is then performed in the MMS-profile mode to increase the density of the cloud of points.

Alternatively or additionally, a static scan can be performed at the positions specified by the onboard PC 40 or at the positions specified by the user. These mobile and static scans are then performed according to the procedure in FIG. 8 until the quality of the mobile data set and the trajectory meets the specifications and the measurement process can be ended.

As explained above, the mobile data set can also be acquired by combining two 3D laser scanners or two 2D laser scanners positioned at an angle to each other or a combination of a 3D laser scanner with a 2D laser scanner.

Disclosed are a mobile scanning assembly and a method for driving such a scanning assembly, which allows a very flexible execution of a measuring procedure in a SLAM rotation mode, an MMS profile mode and/or using a static scan and an evaluation via an onboard PC to optimize the trajectory and the resulting 3D cloud of points.

### LIST OF REFERENCE SYMBOLS

1 mobile scanning assembly
2 laser scanner
4 tripod
6 camera system
8 platform
10 accumulator
11 rotor
12 cargo backpack
13 slanted surface
14 laser beams
15 large area
16 handheld device
17 narrow side
18 battery compartment
20 thread hole
22 thread hole
24 receptacle
26 stand
28 base plate
30 bottom
32 fastening thread
34 support flange
36 housing region
38 housing region
40 onboard PC, communication module
42 SSD
44 central processor

What is claimed is:

1. A mobile scanning assembly comprising at least one scanning device mounted on a platform for 2D or 3D measurement of objects/regions, wherein the platform is guided in such a way that it can be moved along a predetermined path of movement, and having a computing unit that is in data connection with the scanning device, and having a device for location detection, wherein the computing unit is adapted to evaluate the data determined via the scanning device, which is operated preferably in an MMS rotation mode, and the device for location detection, and to determine a trajectory of the scanning assembly, wherein the computing unit is adapted, in an event of insufficient data quality of the trajectory or of a 3D cloud of points, to determine at least one position for additionally performing a static scan or a specification for performing a further mobile scan in an MMS profile mode of the scanning device and to output corresponding information.

2-15. (canceled)

16. The scanning assembly according to claim 1, wherein the MMS rotation mode is an MMS SLAM rotation mode.

17. The scanning assembly according to claim 1, wherein the computing unit is synchronized with an evaluation unit of at least one scanning device and is adapted to process the scan and location data acquired in mobile and static mode with an aim of registration in a field.

18. The scanning assembly according to claim 17, wherein the computing unit is adapted to synchronize processed data sets/scan data back to the evaluation unit of the scanning device.

19. The scanning assembly according to claim 17, wherein a pre-registration is carried out via an external computing unit which is in data connection with the scanning device, or via the computing unit.

20. The scanning assembly according to claim 19, wherein the external computing unit is a tablet.

21. The scanning assembly according to claim 1, wherein the computing unit has an interface for an external memory on which project data can be stored.

22. The scanning assembly according to claim 21, wherein the external memory is an SSD or a USB stick.

23. The scanning assembly according to claim 1, wherein the platform has at least two receptacles for optional positioning of a scanning device or for positioning of at least two scanning devices.

24. The scanning assembly according to claim 23, wherein the receptacles are set at an angle to each other.

25. The scanning assembly according to claim 23, wherein several accumulators are held on the platform, which are connected in such a way that individual accumulators can be replaced without interrupting the scanning process.

26. The scanning assembly according to claim 1, wherein the scanning device is a 3D scanner, a 2D laser scanner or a camera.

27. The scanning assembly according to claim 1, wherein the location detection device is an IMU/INS-based or GNSS-based system or a system using localization techniques such as radar, Bluetooth, ultrasound, RFID.

28. A method for driving a mobile scanning assembly with at least one scanning device that is positioned on a platform and with a computing unit that is synchronized with the scanning device,
comprising:
generating at least one mobile data set associated with a region to be measured in an MMS SLAM-rotation mode of the scanning device;
evaluating the mobile data set and determining a trajectory via the computing unit;
analyzing the trajectory and the mobile data set;
outputting a signal for performing at least one static scan at a location determined by the computing unit or outputting a signal for performing at least one further mobile scan in an MMS profile mode of the scanning device; and
evaluating the static scan and/or an additional mobile scan to determine a corrected mobile data set and a corrected trajectory.

29. The method according to claim 28, wherein the corrected mobile data set is synchronized with the scanning device via the computing unit.

30. The method according to claim 28, wherein, on a basis of the corrected data set, a pre-registration or a correction of a registration is carried out in a field via the computing unit or via an external computer in data connection with the scanning device.

31. The method according to claim 28, wherein the data sets processed by the computing unit or the scanning device are stored on an external memory.

32. The method according to claim 28, wherein the scanning assembly is a 3D laser scanner, via which a first mobile data set is generated in an MMS rotation mode and, if applicable, the static scan, and wherein at least a second mobile data set is generated via the 3D laser scanner operated in a profile mode along a same path of movement or via a further 2D laser scanner held on the platform.

33. The method according to claim 32, wherein the first mobile data set is generated in an MMS SLAM rotation mode.

34. The method according to claim 28, wherein the scanning device for the static scan is removed from the platform.

35. The method according to claim 28, wherein the scanning assembly is designed according to claim 1.
